(19) United States
(12) Patent Application Publication
(10) Pub. No.: US 2004/0202799 A1
(43) Pub. Date: Oct. 14, 2004

(54) Optical compensator with crosslinked surfactant addenda and process

(75) Inventors: Charles L. Bauer, Webster, NY (US); Joseph W. Hoff, Fairport, NY (US); Jason A. Payne, Rochester, NY (US); Mridula Nair, Penfield, NY (US)

Correspondence Address: Paul A. Leipold, Patent Legal Staff, Eastman Kodak Company, 343 State Street, Rochester, NY, 14650-2201, US

(73) Assignee: Eastman Kodak Company

(21) Appl. No.: 10/411,470

(22) Filed: Apr. 10, 2003

(51) Int. Cl. C09K 19/00

(52) U.S. Cl. 428/1.3

(57) ABSTRACT

Disclosed is an optical compensator and process for a liquid crystal display comprising a transparent polymeric support, an orientation layer, and an optically anisotropic layer, in order, and optionally, other layers, wherein a chemically bound surfactant is contained in at least one layer. The uniformity and quality of the film is enhanced by the use of a chemically bound surfactant in a layer.

### CROSS REFERENCE TO RELATED APPLICATION

Commonly assigned application U.S. Ser. No. 10/195,093 filed 12 Jul. 2002, describes the addition of surfactants to optical anisotropic layers to improve coating uniformity without affecting tilt angle.

### FIELD OF THE INVENTION

This invention relates to an optical compensator for improving viewing angle characteristics of liquid crystal displays having a substrate, an orientation layer, an optical anisotropic layer and optional auxiliary layers including barrier layers, antistatic layers, and adhesion promoting layers. To improve layer uniformity and obtain optimum viewing angle characteristics at least one of the said orientation layer, optical anisotropic layer or auxiliary layers contain a chemically bound surfactant.

### BACKGROUND OF THE INVENTION

Current rapid expansion in the liquid crystal display (LCD) applications in various areas of information display is largely due to improvements of display qualities. Contrast, color reproduction, and stable gray scale intensities are important quality attributes for electronic displays, which employ liquid crystal technology. The primary factor limiting the contrast of a liquid crystal display is the propensity for light to “leak” through liquid crystal elements or cell, which are in the dark or “black” pixel state. Furthermore, the leakage and hence contrast of a liquid crystal display are also dependent on the angle from which the display screen is viewed. Typically the optimum contrast is observed only within a narrow viewing angle centered about the normal incidence to the display and falls off rapidly as the viewing angle is increased. In color displays, the leakage problem not only degrades the contrast but also causes color or hue shifts with an associated degradation of color reproduction. In addition to black-state light leakage, the narrow viewing angle problem in typical twisted nematic liquid crystal displays is exacerbated by a shift in the brightness-voltage curve as a function of viewing angle because of the optical anisotropy of the liquid crystal material.

Thus, one of the major factors measuring the quality of such displays is the viewing angle characteristic, which describes a change in contrast ratio from different viewing angles. It is desirable to be able to see the same image from a wide variation in viewing angles and this ability has been a shortcoming with liquid crystal display devices. One way to improve the viewing angle characteristic is to insert a compensator (also referred as compensation film, retardation film, or retarder) with proper optical properties between the polarizer and liquid crystal cell, such as disclosed in U.S. Pat. Nos. 5,583,679 (Ito et al.), 5,853,801 (Suga et al.), 5,619,352 (Koch et al.), 5,978,055 (Van De Witte et al.), and 6,160,597 (Schadt et al.). A compensation film according to U.S. Pat. Nos. 5,583,679 (Ito et al.) and 5,853,801 (Suga et al.), based on discotic liquid crystals which have negative birefringence, is widely used. It offers improved contrast over wider viewing angles, however, it suffers larger color shift for gray level images, compared to a compensator made of liquid crystalline materials with positive birefringence, according to Satoh et al. (“Comparison of nematic hybrid and discotic hybrid films as viewing angle compensator for NW-TN-LCDs”, SID 2000 Digest, pp. 347-349, (2000)). To achieve comparable performance in the contrast ratio while reducing color shift, one alternative is to use a pair of crossed liquid crystal polymer films (LCP) on each side of liquid crystal cell, as discussed by Chen et al. (“Wide Viewing Angle Photoaligned Plastic Films”, SID 99 Digest, pp.98-101 (1999)). This paper states that “since the second LPP/LCP retarder film is coated directly on top of the first LCP retarder film, the total thickness of the final wide-view retarder stack is only a few microns thin”. Although they provide very compact optical component, one of the challenges of this method is to make two LCP layers crossed, particularly in a continuous roll to roll manufacturing process.

The compensating films are prepared by coating the LPP/LCP materials from organic solvents onto a transparent substrate. The Theological properties of the LPP/LCP materials in organic solvents, coupled with the thin nature of the applied materials when in the liquid state on the substrate, leave the coated materials susceptible to post-application imperfections which include, but are not limited to, mottle, drying convection cells, and repellencies. These post-application imperfections can cause spatial variations in the thickness of the thin film when in its final cured state. These variations in thickness will result in localized contrast variations when the compensating film is viewed through crossed-polarizers, or more importantly, when used in a full LCD cell.

U.S. Pat. No. 5,583,679 discloses the addition of surface active agents (i.e., surfactants) to optical anisotropic layers containing discotic liquid crystal compounds in order to change the tilt angle (also referred to as the incline angle) of the discotic liquid crystalline compound.

It is desirable to provide an optical compensator that widens the viewing angle characteristics of liquid crystal displays, in particular Twisted Nematic (TN), Super Twisted Nematic (STN), Optically Compensated Bend (OCB), In Plane Switching (IPS), or Vertically Aligned (VA) liquid crystal displays, is readily manufactured, and has coated layers having improved uniform spatial thickness. These various liquid crystal display technologies have been reviewed in U.S. Pat. Nos. 5,619,352 (Koch et al.), 5,410,422 (Bos), and 4,701,028 (Clerc et al.). It is useful to incorporate surfactants into one or more layers of a compensator for manufacturing and product performance reasons; however surfactants added to layers may diffuse or migrate into other layers especially when liquid coated layers are applied on surfactant containing layers. This migration of the surfactant may cause unwanted coating defects or contaminate or degrade the performance of the applied coating.

It is a problem to be solved to employ surfactants in compensator layers without causing unwanted coating defects or contamination or degradation of the performance of the compensator.

### SUMMARY OF THE INVENTION

The invention provides an optical compensator and process for a liquid crystal display comprising a transparent polymeric support, an orientation layer, and an optically anisotropic layer, in order, and optionally, other layers, wherein a chemically bound surfactant is contained in at least one layer. The addition of a chemically bindable surfactant improves coated layer uniformity and, contrary to the prior art does not change the tilt angle of the liquid crystalline layer in the optical compensation film or result in the migration of the surfactant to adjacent layers.

The optical compensator of the present invention widens the viewing angle characteristics of liquid crystal displays, and in particular of Twisted Nematic (TN), Super Twisted Nematic (STN), Optically Compensated Bend (OCB), In Plane Switching (IPS), or Vertically Aligned (VA) liquid crystal displays, is readily manufactured in a roll-to-roll coatable process with excellent layer uniformities and optical properties.

### BRIEF DESCRIPTION OF THE DRAWINGS

FIG. 1 is a cross-sectional schematic view of a compensator of the present invention.

FIGS. 2A and 2B are cross-sectional schematic views of various embodiments of the present invention.

FIG. 3 is a schematic concept in accordance with the present invention.

FIG. 4 shows a liquid crystal display in combination with a compensator according to the present invention.

FIG. 5 shows a roll-to-roll process for making a compensator according to the present invention.

### DETAILED DESCRIPTION OF THE INVENTION

The current invention regarding the optical compensator for liquid crystal displays is described by referring to the drawings as follows.

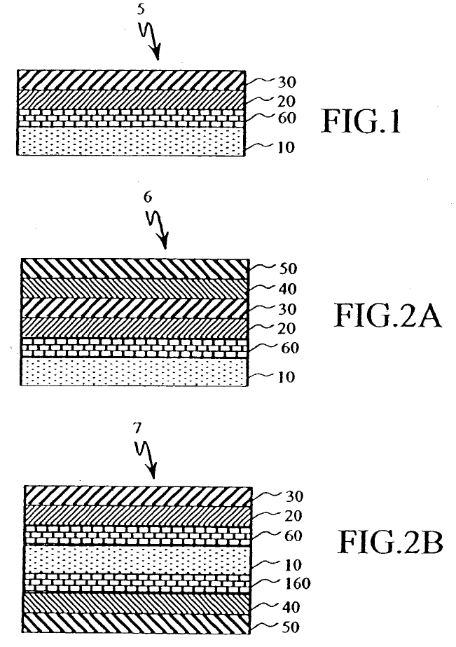

FIG. 1 shows a cross-sectional schematic view of an optical compensator 5 according to the present invention. This compensator comprises a substrate 10 of transparent material, such as glass or polymer. It should be understood that to be called as a substrate, a layer must be solid and mechanically strong so that it can stand alone and support other layers. A typical substrate is made of triacetate cellulose (TAC), polyester, polycarbonate, polysulfone, polyethersulfone, cyclic polyolefin or other transparent polymers, and has a thickness of 25 to 500 micrometers. Substrate 10 typically has low in-plane retardation, preferably less than 10 nm, and more preferably less than 5 nm. In some other cases, the substrate 10 may have larger in-plane retardation between 15 to 150 nm. Typically, when the substrate 10 is made of triacetyl cellulose, it has out-of-plane retardation around −40 nm to −120 nm. This is a desired property when the compensator is designed to compensate a liquid crystal state with an ON voltage applied. The in-plane retardation discussed above is defined as the absolute value of (nx−ny)d and the out-of-plane retardation discussed above is defined as [(nx+ny)/2−nz]d, respectively. The refractive indices nx and ny are along the slow and fast axes in plane of the substrate, respectively, nz is the refractive index along the substrate thickness direction (Z-axis), and d is the substrate thickness. The substrate is preferably in the form of a continuous (rolled) film or web.

On the substrate 10, an orientation layer 20 is applied, and an anisotropic layer 30 is disposed on top of layer 20. If desired, auxiliary layers between the substrate and orientation layer may be used to improve adhesion, provide antistatic properties, or provide barrier properties to prevent intermixing or interdiffusion of materials between the substrate and the orientation layer.

The orientation layer 20 can be oriented by various techniques one example, the orientation layer contains a rubbing-orientable material such as a polyimide or polyvinyl alcohol and can be oriented by a rubbing technique. In another example, the orientation layer contains a shear-orientable material and can be oriented by a shear-alignment technique. In another example, the orientation layer contains an electrically- or magnetically-orientable material and can be oriented by an electrical- or magnetic-alignment technique. In another example, the orientation layer can also be a layer of SiOx fabricated by oblique deposition. In another example, the orientation layer contains a photo-orientable material and can be oriented by a photo-alignment technique. Photo-orientable materials include, for example, photo isomerization polymers, photo dimerization polymers, and photo decomposition polymers. In a preferred embodiment, the photo-orientable materials are cinnamic acid derivatives as disclosed in U.S. Pat. No. 6,160,597. Such materials may be oriented and simultaneously crosslinked by selective irradiation with linear polarized UV light.

The anisotropic layer 30 is typically a liquid crystalline monomer when it is first disposed on the orientation layer 20, and is cross-linked by a further UV irradiation, or polymerized by other means such as heat. In a preferred embodiment, the anisotropic layer contains a material such as a diacrylate or diepoxide with positive birefringence as disclosed in U.S. Pat. No. 6,160,597 (Schadt et al.) and U.S. Pat. No. 5,602,661 (Schadt et al.). In another embodiment, the anisotropic layer contains a material with negative birefringence, such as a discotic liquid crystal disclosed in U.S. Pat. No. 5,583,679 (Ito et al.). The optic axis in the anisotropic layer 30 is usually tilted relative to the layer plane, and varies across the thickness direction.

In accordance with the present invention one or more of the orientation layer 20, the optical anisotropic layer 30, or an auxiliary layer may contain a chemically bound surfactant. Chemically bindable surfactants are those capable of reacting with each other or other layer components during the manufacturing process such as by polymerization (including crosslinking) and include, but are not limited to: fluorinated surfactants containing a reactive functional group including polymeric fluorochemicals such as fluoro(meth)acrylate polymers; fluorotelomers such as those having the structure R_{f}CH₂CH₂OOC—C₁₇H₃₄X or (R_{f}CH₂CH₂OOC)₃C₃H₄OX, wherein R_{f} is CF₃CF₂(CF₂CF₂)_{x=2 to 4}, ethoxylated nonionic fluorochemicals such as those having the general structure R_{f}CH₂CH₂O(CH₂CH₂O)_{y}H, wherein R_{f} is CF₃CF₂(CF₂CF₂)_{x=2 to 4},; fluorosilcones and fluorinated polyethers such as those having the general repeating stucture (CH₂C(CH₃)(CH₂OR_{f})CH₂)ₙ wherein Rf is CH₂CF₃ or CH₂CF₂CF₃; silicone surfactants containing a reactive functional group; or polyethers, laureates, palmitates, and stearates containing a reactive functional group, wherein the reactive functional group is a vinyl group, carbon double bond, epoxy, aziridine, carboxylic acid, amine, triazine, aldehyde, or hydroxy group.

Desirable chemically bindable surfactants for use in the present invention are fluorinated surfactants containing a reactive functional group. Of these, fluorinated surfactants containing one or more acrylate groups are particularly desirable. Commercially available examples of such surfactants include Zonyl 8857A available from DuPont and PolyFox PF-3320 available from Omnova Solutions Inc. Such surfactants are preferred due to their effectiveness at very low concentrations and their ability to copolymerize with other acrylate monomers.

The concentration of the chemically bindable surfactant can vary depending on the coating method for applying the layer, and the concentration is based on the amount of coating solution applied to the substrate. Preferred concentrations of such surfactants are 0.001% to 0.1% by weight of the coating solution. Typically in the dried layer, this corresponds to a range from 0.001% to 1.0 wt % depending on the coating method employed. Most preferred are chemically bindablesurfactant concentrations between 0.01% and 0.05% by weight of the coating solution. Typically in the dried layer, this corresponds to a range from 0.01% to 1.0 wt % depending on the coating method employed. The orientation layer, anisotropic layer or auxiliary layer of the invention may contain one chemically bound surfactant or a mixture of different chemically bound surfactants.

The orientation layer, anisotropic layer or auxiliary layer may also contain addenda such as non-chemically bindable surfactants, light stabilizers and UV initiators. UV initiatiors include materials such as benzophenone and acetophenone and their derivatives; benzoin, benzoin ethers, benzil, benzil ketals, fluorenone, xanthanone, alpha and beta naphthyl carbonyl compounds and ketones. Preferred initiators are alpha-hydroxyketones.

While this type of compensator described above provides some desired optical properties, it is not sufficient in many applications, for example, as a compensator for Twisted Nematic (TN) Liquid Crystal Displays (LCDs).

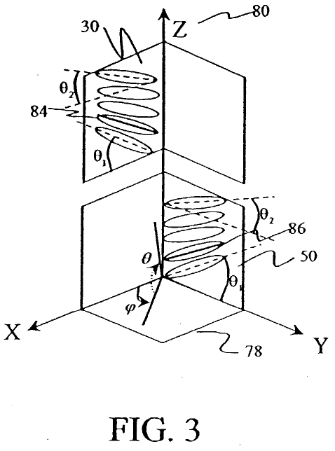

FIG. 2A illustrates a more sophisticated optical compensator 6 of the invention that contains a second orientation layer 40 and a second anisotropic layer 50 on top of the first anisotropic layer 30. The second orientation layer 40 and the second anisotropic layer 50 are made essentially in the same way as the first orientation layer 20 and the first anisotropic layer 30 are made, except that the direction of the orientation may vary. For the purpose of illustration, refer to an XYZ coordinate system 80 as shown in FIG. 3. The X and Y axes are parallel to the plane of substrate 78, and the Z-axis is perpendicular to the plane of substrate 78. The angle φ is measured from the X-axis in the XY plane, and referred as an azimuthal angle. The angle θ is measured from the XY plane, and referred as a tilt angle.

It should be understood that the optic axis in each of the anisotropic layers 30 and 50 can have a variable tilt angle and/or variable azimuthal angle. For example, the optic axis 84 in the anisotropic layer 30 has a variable tilt angle θ across the Z-axis ranging from θ₁ to θ₂. In another example, the optic axis 84 has a fixed tilt angle θ across the Z-axis, namely, θ₁=θ₂. In another example, the optic axis 84 is contained in one plane such as the XZ plane and consequently has a fixed azimuthal angle φ across the Z-axis. In another example, although the anisotropic layer 30 is still oriented along the preferred direction forced by the orientation layer at their interface, the optic axis 84 has a variable azimuthal angle φ across the Z-axis. The azimuthal angle of the optic axis 84 can be varied by adding a proper amount of chiral dopant into the anisotropic layer 30. In another example, the optic axis 84 has a variable tilt angle θ and a variable azimuthal angle φ across the Z-axis. Like the optic axis 84 of the anisotropic layer 30, the optic axis 86 of the anisotropic layer 50 can also have a fixed tilt angle, a variable tilt angle, a fixed azimuthal angle, a variable azimuthal angle, or a variable tilt angle and a variable azimuthal angle across the Z-axis. The anisotropic layers 30 and 50 typically have different optic axis. Preferably the anisotropic layer 30 is positioned orthogonally relative to the respective optic axis of the anisotropic layer 50 about an axis perpendicular to the plane of the substrate. Even though the optic axis of the anisotropic layer 30 is preferred to be orthogonal (or ±90 degrees) relative to the respective (or counterpart) optic axis of the anisotropic layer 50 about an axis perpendicular to the plane of the substrate, it should be understood that the angle between the optic axis of the two anisotropic layers can be in a range of 85 to 95 degrees to be considered as orthogonal.

For the manufacture of more complex layer structures than that illustrated in FIG. 2A, additional orientation and anisotropic layers can be applied in further steps.

FIG. 2B illustrates another optical compensator 7 of the invention in which the second orientation layer 40 and the second anisotropic layer 50 are on the opposite side of the substrate from the first orientation layer 20 and the first anisotropic layer 30.

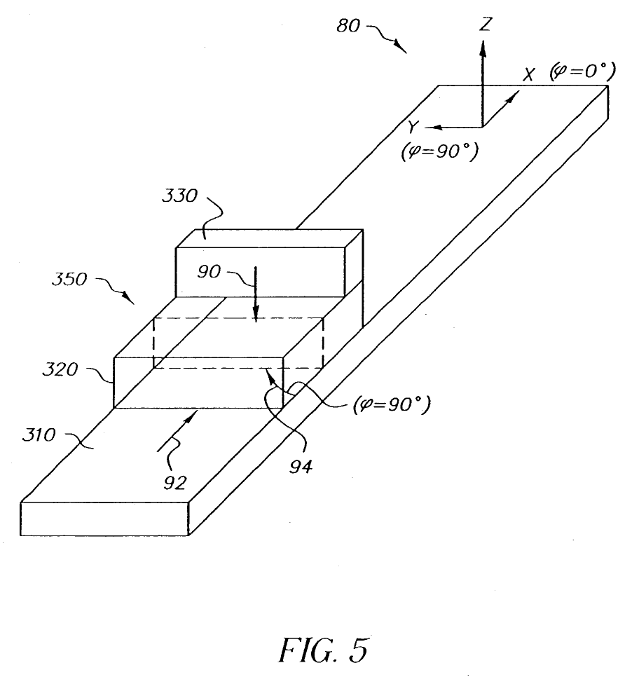

FIG. 5 shows another aspect of the present invention. A compensator 350 can be manufactured on a continuous roll-to-roll basis as shown in FIG. 5 which shows part of a schematic view of the process. The roll-to-roll process of forming a compensator 350 comprises the steps of applying a photo-alignable orientation layer 320, for example by coating by any known method such as extrusion hopper coating, roll-coating, slide hopper coating, or curtain coating, the orientable material in a solvent, onto a moving substrate 310, drying the orientation layer 320, photo-aligning (orienting) the orientation layer 320 in a predetermined alignment direction φ94, (for the purpose of illustration φ=90°) relative to the roll moving direction 92, coating (as described earlier)an anisotropic layer 330 comprising a polymerizable material in a solvent carrier onto the orientation layer 320, drying the anisotropic layer 330, polymerizing the anisotropic layer 330 to form a continuous web of compensator. Note that for clarity, FIG. 5 only shows part of the orientation layer 320 and anisotropic layer 330.

In one embodiment, the orientation layer is oriented by rubbing the orientation layer in a direction 94 of 90 degrees (φ=90°) relative to the roll moving direction 92. In another embodiment, the orientation layer is oriented by a photo-alignment technique, for example, the orientation layer is exposed to a linearly polarized ultraviolet (UV) light indicated by 90. It may or may not be collimated, however, the projection (pointing along 94) of the principal ray of the light 90 onto the roll makes an angle of about 90 degrees relative to the roll moving direction.

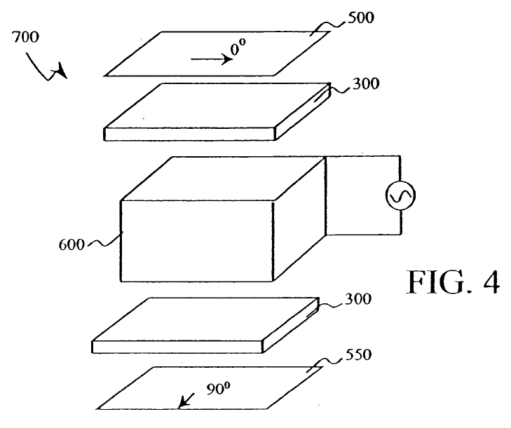

FIG. 4 is a schematic view of a liquid crystal display 700 comprising the compensator 300 in accordance with the present invention. In FIG. 4B, one compensator 300 is placed between the first polarizer 500 and the liquid crystal cell 600, and another compensator 300 is placed between a second polarizer 550 and the liquid crystal cell 600. The liquid crystal cell 600 is preferred to be operated in a Twisted Nematic (TN), Super Twisted Nematic (STN), Optically Compensated Bend (OCB), In Plane Switching (IPS), or Vertically Aligned (VA) mode. The polarizers 550 and 500 can be arranged crossed or parallel depending on the operation principles of the liquid crystal cell. The orientation layer in the compensator can be arranged parallel, perpendicular, or at a predetermined angle relative to the first polarizer 500. The liquid crystal cell can also be operated in a reflective mode, in which it may only require one polarizer.

The invention may be used in conjunction with electronic imaging device comprising a liquid crystal display device. The energy required to achieve this control is generally much less than that required for the luminescent materials used in other display types such as cathode ray tubes. Accordingly, liquid crystal technology is used for a number of applications, including but not limited to digital watches, calculators, portable computers, electronic games for which light weight, low power consumption and long operating life are important features.

The present invention is illustrated in more detail by the following non-limiting examples.

### EXAMPLES

Materials

The UV curable lacquer SK3200 was obtained from Sony Chemicals Corporation. CX100, a trifunctional crosslinker, was obtained from NeoResins (a division of Avecia). Sancure 898, an aliphatic polyester based polyurethane, was purchased from BFGoodrich. The LPP polymer Staralign 2110 (polyvinyl cinnamate with an alpha-hydroxyketone photoinitiator in methyl ethyl ketone) and the diacrylate nematic liquid crystal (LCP) prepolymer, CB483 (in methyl ethyl ketone) were obtained from Vantico.

### Example 1

(Compliant Layer: An Auxiliary Layer)

An 80 micrometer thick triacetyl cellulose support was corona discharge treated and then coated with an aqueous polyurethane solution which after drying at 100° C. had the following dried composition: 70 g/m² Sancure 898 and 0.7 g/m² CX100.

(Photochemically Cured Barrier Layer: An Auxiliary Layer)

A coating solution of the following composition containing SK3200 was coated on the compliant layer to create a barrier layer using an extrusion hopper. The coated layer was dried and crosslinked using UV irradiation at 320 to 400 nm at 365 mj/cm² to form a transparent barrier layer having a dried weight of 1.7 g/m².

| | |
|---|---|
| Propyl acetate | 85% |
| SK3200 | 15% |

(Alignment Layer)

On top of the crosslinked SK3200 polymer layer a photoalignment layer was coated from the following solution to obtain a dry coverage of 0.076 g/m². After drying to remove solvents, the sample was exposed to linearly polarized UVB at 308 nm using 10-30 mJ/cm² light at a 20° angle.

| | |
|---|---|
| Staralign 2110 | 0.48% |
| Methyl ethyl ketone | 31.52% |
| Cyclohexanone | 22.75% |
| n-Propyl acetate | 40.00% |

(Optically Anisotropic Layer)

A solution of a diacrylate nematic liquid crystal material, CB483 of the following composition was coated onto the orientation layer to obtain a dry coverage of 0.796 g/m². After drying, the coated structure was exposed to 400 mJ/cm² of UVA to crosslink the liquid crystal layer. This resulted in the liquid crystal retarder film.

| | |
|---|---|
| LC material CB483 | 8.7% |
| Methyl ethyl ketone | 20.3% |
| Toluene | 62.00% |
| Ethyl acetate | 9.00% |

Samples 1 through 4 were prepared by adding different surfactants to the optically anisotropic layer. Table 1 below details the surfactant employed and the results obtained. Each sample was then viewed between crossed polarizing filters to determine the effect of the surfactant on the resulting dried anisotropic layer uniformity, and a visual rating was assigned. The rating considered all obvious post-application imperfections, including mottle, drying convection cells, and repellencies. A rating of 1 corresponds to the poorest possible quality and a rating of 10 the best possible quality.

S1: Modiper F-600, a fluoro(meth)acrylate polymer surfactant available from NOF Corp.

S2: Zonyl FSG, a fluoro(meth)acrylate polymer surfactant available from DuPont

S3: PolyFox PF-3320 a crosslinkable diacrylate fluorinated polyether from Omnova Solutions Inc.

TABLE 1

| Sample Number | Surfactant | Concentration | Rating |
|---|---|---|---|
| 1 | No Surfactant | 0.0% | 1 |
| 2 | S1 | 0.02% | 4 |
| 3 | S2 | 0.02% | 5 |
| 4 | S3 | 0.02% | 9 |

The results of Example 1 demonstrate the advantage of the invention in that the inclusion of the diacrylate surfactant improved the coated layer quality of Sample 4 as compared to Sample 1 in which no surfactant was present and the Samples 2 and 3 which contain non-reactive surfactants.

### Example 2

(Compliant Layer: An Auxiliary Layer)

An 80 micrometer thick triacetyl cellulose support was corona discharge treated and then coated with an aqueous polyurethane solution which after drying at 100° C. had the following dried composition: 70 g/m² Sancure 898 and 0.7 g/m² CX100.

(Photochemically Cured Barrier Layer: An Auxiliary Layer)

A coating solution of the following composition containing SK3200 was coated on the compliant layer to create a barrier layer using an extrusion hopper. The coated layer was dried and crosslinked using UV irradiation at 320 to 400 nm at 365 mj/cm² to form a transparent barrier layer having a dried weight of 1.7 g/m².

| | |
|---|---|
| Propyl acetate | 85% |
| SK3200 | 15% |

(Alignment Layer)

On top of the crosslinked SK3200 polymer layer a photoalignment layer was coated from the following solution to obtain a dry coverage of 0.076 g/m². After drying to remove solvents, the sample was exposed to linearly polarized UVB at 308 nm using 10-30 mJ/cm² light at a 20° angle.

| | |
|---|---|
| Staralign 2110 | 0.48% |
| Methyl ethyl ketone | 31.52% |
| Cyclohexanone | 22.75% |
| n-Propyl acetate | 40.00% |

Samples 5 through 9 were prepared by adding different surfactants to the photochemically cured barrier layer. Table 2 below details the surfactant employed. After drying the alignment layer, the surface composition was analyzed using X-ray photoelectron spectroscopy. The atomic percent fluorine detected at the surface is related to the amount of fluorinated surfactant that migrated from the barrier layer to the top of the alignment layer. A low value for fluorine would indicate that the surfactant was not able to diffuse to the surface. The results are shown in Table 2 below.

S1: Modiper F-600, a fluoro(meth)acrylate polymer surfactant available from NOF Corp.

S2: Zonyl FSG, a fluoro(meth)acrylate polymer surfactant available from DuPont

S3: PolyFox PF-3320 a diacrylate fluorinated polyether from Omnova Solutions Inc.

TABLE 2

| | | | Atomic |
|---|---|---|---|
| | | | % Fluoine |
| Sample Number | Surfactant | Concentration | from XPS |
| 5 | S1 | 0.01% | 1.42 |
| 6 | S1 | 0.02% | 3.67 |
| 7 | S2 | 0.01% | 6.46 |
| 8 | S2 | 0.02% | 17.66 |
| 9 | S3 | 0.01% | 0.36 |

These results show that the surfactant with the chemically bindable diacrylate group, S3, was not able to migrate through the subsequent applied layer compared to the other samples.

The entire contents of the patents and other publications referred to in this specification are incorporated herein by reference.

### Parts list

5 compensator according to the present invention

6 compensator according to the present invention

7 compensator according to the present invention

10 substrate

20 orientation layer

30 anisotropic layer

40 orientation layer

50 anisotropic layer

78 plane of substrate (or XY plane)

80 XYZ coordinate system

84 optic axis in the anisotropic layer 30

86 optic axis in the anisotropic layer 50

90 UV light

92 roll moving direction

94 alignment direction

300 compensator according to the present invention

310 moving substrate

320 orientation layer

330 anisotropic layer

350 compensator according to the present invention

500 polarizer

550 polarizer

600 liquid crystal cell

700 liquid crystal display

θ tilt angle

φ azimuthal angle

1. An optical compensator for a liquid crystal display comprising a transparent polymeric support, an orientation layer, and an optically anisotropic layer, in order, and optionally, other layers, wherein a chemically bound surfactant is contained in at least one layer.

2. The compensator of claim 1 wherein the chemically bound surfactant is present in the anisotropic layer.

3. The compensator of claim 1 wherein the compensator comprises a barrier layer containing the chemically bound surfactant.

4. The compensator of claim 1 wherein the surfactant is one polymerized by UV exposure.

5. The compensator of claim 1 wherein the surfactant is one polymerized by heat.

6. The compensator of claim 1 wherein the chemically bound surfactant is present in an amount of 0.001 to 1.0 wt % of the layer it is in.

7. The compensator of claim 1 wherein the chemically bound surfactant is present in an amount of 0.01 to 1.0 wt % of the layer it is in.

8. The compensator of claim 1 wherein the chemically bound surfactant is a cationic surfactant.

9. The compensator of claim 1 wherein the chemically bound surfactant is an anionic surfactant.

10. The compensator of claim 1 wherein the chemically bound surfactant is a nonionic surfactant.

11. The compensator of claim 1 wherein the chemically bound surfactant comprises a moiety selected from fluoride, silicone, polyalkylene oxide, fatty acid salts and esters.

12. The compensator of claim 1 wherein the chemically bound surfactant is a fluorinated surfactant.

13. The compensator of claim 12 wherein the chemically bound surfactant is present in the anisotropic layer in an amount of from 0.001% to 1.0 wt %.

14. The compensator of claim 12 wherein the chemically bound surfactant is present in the anisotropic layer in an amount of from 0.01% to 1.0 wt %.

15. The compensator of claim 12 wherein the chemically bound fluorinated surfactant contains a perfluorinated alkylene segment.

16. The compensator of claim 15 wherein the perfluorinated alkylene segment is form 6 to 10 carbons in length.

17. The compensator of claim 12 wherein the chemically bound surfactant contains a fluoro(meth)acrylate polymer moiety.

18. The compensator of claim 12 wherein the chemically bound surfactant contains a fluorinated polyether.

19. The compensator of claim 1 wherein the chemically bound surfactant contains a silicone moiety.

20. The compensator of claim 1 wherein the chemically bound surfactant contains a fatty acid salt or ester moiety.

21. The compensator of claim 1 wherein said transparent support comprises a cellulose ester.

22. The compensator of claim 1 wherein said transparent support comprises a polycarbonate.

23. The compensator of claim 1 wherein the orientation layer is oriented through photoalignment using polarized light.

24. The compensator of claim 22 wherein the orientation layer comprises a polyvinyl cinnamate.

25. The compensator of claim 1 wherein said anisotropic layer comprises a nematic liquid crystal.

26. (Currently amended) The compensator of claim 25 wherein the nematic liquid crystal is a UV crosslinked material.

27. A liquid crystal display comprising a compensator of claim 1.

28. and 29 (Canceled)

30. The compensator of claim 1 wherein the chemically bound surfactant is polymerized.

31. The compensator of claim 1 wherein the chemically bound surfactant is crosslinked.

32. A process for preparing a compensator for a liquid crystal display comprising providing a transparent support, coating an orientation layer from an organic solvent over the support and then drying and aligning the orientation layer, and then coating and polymerizing an anisotropic liquid crystal layer comprising a polymerizable material in a solvent carrier over the orientation layer, wherein at least one layer of the compensator contains a heat or UV polymerizable surfactant which is chemically bound after coating.

33. A process for making an optical compensator, comprising the steps of:
a) coating an orientation layer comprising a photo-alignable polymer in a solvent over a transparent support;
b) drying the orientation layer;
c) photo-aligning the orientation layer in a predetermined direction;
d) coating an anisotropic liquid crystal layer comprising a polymerizable material in a solvent carrier over the orientation layer;
e) drying the anisotropic layer;
f) polymerizing the anisotropic layer;
g) chemically binding the surfactant;
h) provided that at least one layer contains a heat or UV polymerizable surfactant that is chemically bound after coating;
i) repeating a) through h) coating over the polymerized anisotropic layer of h) but photo-aligning the orientation layer at a predetermined angle to the direction in step c).

34. A continuous process for making an optical compensator on a support web, comprising the steps of:
a) coating an orientation layer comprising a photo-alignable polymer in an organic solvent over the support;
b) drying the orientation layer;
c) photoaligning the orientation layer in a predetermined direction relative to the web moving direction;
d) coating an anisotropic layer comprising a polymerizable material and a surfactant compound in a solvent carrier onto the orientation layer;
e) drying the anisotropic layer;
f) polymerizing the anisotropic layer to form a first continuous web of a multilayer integral component;
g) provided that at least one layer contains a heat or UV polymerizable surfactant that is chemically bound after coating;
h) repeating the above steps a) through f) coating over the anisotropic layer obtained from e) but photo-aligning the orientation layer at a predetermined angle to the direction in step c).

35. The process of claim 34 wherein the surfactant is present in an amount of from 0.01 to 0.05 wt % of the liquid crystal coating material as applied.

36. The process of claim 34 wherein the surfactant comprises a moiety selected from fluoride, silicone, polyalkylene oxide, fatty acid salts and esters.

37. The process of claim 34 wherein the surfactant comprises a moiety selected from fluoride and silicone.

38. The process of claim 34 wherein the surfactant comprises a fluorinated surfactant.

39. The process of claim 34 wherein the fluorinated surfactant comprises a perfluorinated alkylene segment.
